(19) United States
(12) Patent Application Publication
(10) Pub. No.: US 2022/0061314 A1
(43) Pub. Date: Mar. 3, 2022

(54) PLANT GROWTH REGULATOR IN A SEMISOLID OR VISCOUS MEDIUM

(71) Applicant: Grospurt, Bremerton, WA (US)

(72) Inventor: Kenneth Curry, Bremerton, WA (US)

(21) Appl. No.: 17/005,934

(22) Filed: Aug. 28, 2020

(51) Int. Cl. A01N 25/04; A01N 43/38; A01N 31/02; A01N 43/16; A01N 43/54; A01N 25/12

(52) U.S. Cl. CPC A01N 25/04; A01N 43/38; A01N 25/12; A01N 43/16; A01N 43/54; A01N 31/02

(57) ABSTRACT

The present invention is a highly concentrated plant growth regulator suspended in a solid, semisolid, paste, gel, etc. that allows for targeted application and extended, continuous release of the plant growth regulator in the targeted growth-related areas of the plant/tree. The carrier medium is dosed with one or more particulate PGRs, and possibly a fungicide or insecticide, and this composition results in not only a highly effective way to achieve growth, but also allows for a very unique application and benefit on grafted trees by sealing the graft wound and accelerating the regrowth either alone or in combination with traditional treatments. Additionally, the present invention can be used to seal pruning wounds that farmers heretofore have used Latex type products.

### BACKGROUND

There are four major factors that affect the growth of the plants. They are light, water, temperature, and nutrients. Plants are autotrophs and require light for manufacturing their food. Limited light or the absence of it greatly affects the growth of the plant. The intensity of light, quality of light, and light duration influence the movement of stomata, chlorophyll synthesis, photosynthesis, and various other physiological factors. Light also encourages flowering and fruiting. During winters when the days are short, the growth of the plants is retarded. Plants also cannot survive without water. Around 90% of the plant body comprises water. Plants become stressed in the absence of water and die. Water present in the soil is absorbed by the plant, which absorbs and transports the nutrients along with it. Water keeps the plant hydrated. Plant growth is also greatly influenced by temperature. High temperatures speed up transpiration, photosynthesis, and germination processes. Low temperatures, however, slow down the growth of the plants. Nutrients also plays a vital role in the growth of plants.

The final factor of plant growth is nutrients. As with all living things, plants require proper nourishment for their growth and development. Soil nutrients are divided into macronutrients and micronutrients. Nitrogen, potassium, calcium, magnesium, sulfur, and phosphorus are the macronutrients required by the plants. The micronutrients include iron, copper, etc. Deficiency of these nutrients in plants makes them prone to several diseases. Even if a single nutrient is lacking, it results in stunted growth of the plant.

One nutrient of particular significance is the plant growth regulator (PGR). The discovery of major plant growth regulators is attributed to Charles Darwin, who observed the growth of coleoptiles of canary grass towards the light source-phototropism. Following a series of experiments, he concluded the presence of a transmittable substance that influences the growth of canary grass towards the light. That transmittable substance was what was later discovered to be auxin which was isolated later by F. W. Went. Later, many scientists discovered and isolated different plant growth regulators. Gibberellins or gibberellic acid was formerly found in uninfected rice seedlings and was reported by E. Kurosawa. F. Skoog and Miller discovered another growth-promoting substance named kinetin, which is now known as cytokinins.

Plant growth regulators tend to be simple organic molecules having several chemical compositions. They can accelerate as well as retard the rate of growth in plants. Plants growth hormones or plant growth regulators exhibit the following characteristics: Differentiation and elongation of cells; Formation of leaves, flowers, and stems; Wilting of leaves; Ripening of fruit; and Seed dormancy. Generally, there are five types of plant hormones, namely, auxin, gibberellins (GAs), cytokinins, abscisic acid (ABA) and ethylene. In addition to these, there are more derivative compounds, both natural and synthetic, which also act as plant growth regulators.

These compounds are the chemical substances that govern all the factors of development and growth within plants. Plant growth hormones are organic compounds that are either synthesized in laboratories or produced naturally within the plants. They profoundly control and modify the physiological processes like the growth, development, and movement of plants. Based on their effects on the plants, PGRs are broadly classified into two major groups: plant growth promoters and plant growth inhibitors. Auxins, Gibberellins, and Cytokinins are typically grouped into plant growth promoters, while Abscisic acid is usually grouped into plant growth inhibitors. Ethylene, or an ethylene releasing agent such as ethephon, may be grouped either into the promoters or into the plant inhibitors.

Plants undergo various types of plant growth, including primary and secondary growth. In primary growth, the meristematic cells present at the root and shoot apices divide mitotically and increase the length of the plant body. In secondary growth, the increase in the diameter of the plant body occurs by the division of the secondary meristem. When the plant constantly grows from the germination stage to death, it is called unlimited growth, whereas when plant parts stop growing after attaining a certain size this is referred to as limited growth. Vegetative growth involves the production of stem, leaves, and branches (except the flowers), and reproductive growth refers to the flowering stage of growth.

Auxins, derived from the Greek language meaning to grow, are one of the most important plant hormones. The chief naturally occurring auxin is indole-3 acetic acid—IAA and other related compounds. These plant growth regulators are generally produced at the points of stems and roots from where they are transported to other parts of the plants. These plant hormones include both natural and synthetic sources. Indole-3-acetic acid and indole butyric acid are obtained from natural plant sources, whereas naphthalene acetic acid and 2, 4-dichlorophenoxyacetic acid are obtained from synthetic sources. The functions of Auxins include:

Facilitate flowering in plants

Used in the process of plant propagation.

Used by gardeners to keep lawns free from weeds.

Involved in the initiation of roots in stem cuttings.

Prevention of dropping of leaves and fruits at early stages.

Regulate xylem differentiation and assists in cell division.

Used as herbicides to kill dicot weeds.

Used to produce fruit without preceding fertilization.

Promote natural detachment (abscission) of older leaves and fruits.

Gibberellins

Gibberellins are an extensive chemical family based on the ent-gibberellane structure. The first gibberellin to be discovered was gibberellic acid. Now there are more than 100 types of gibberellins and are mainly gathered from a variety of organisms from fungi to higher plants. They are acidic and are denoted as follows—GA1, GA2, GA3 etc. The functions of Gibberellins include:

Delay senescence in fruits.

Involved in leaf expansion.

Break bud and seed dormancy.

Promote bolting in cabbages and beet.

Facilitate elongation of fruits such as apples and enhance their shape.

Used by the brewing industry to accelerate the malting process.

Used as the spraying agent to increase the yield of sugarcane by elongation of the stem.

In young conifers, utilized to fasten the maturity period and facilitate early seed production

Helps in increasing the crop yield by increasing the height in plants such as sugarcane and increase the axis length in plants such as grape stalks.

Cytokinins

Cytokinins are produced in the regions where cell division occurs; mostly in the roots and shoots. They help in the production of new leaves, lateral shoot growth, chloroplasts in leaves etc. They help in overcoming apical dominance and delay ageing of leaves. The function of Cytokinins include:

Break bud and seed dormancy.

Promotes the growth of the lateral bud.

Promotes cell division and apical dominance.

They are used to keep flowers fresh for a longer time.

Used in tissue culture to induce cell division in mature tissues.

Facilitate adventitious shoot formation and lateral shoot growth.

Promote nutrient mobilization that in turn assists delaying leaf senescence.

Helps in delaying the process of ageing (senescence) in fresh leaf crops like cabbage and lettuce.

Involved in the formation of new leaves and chloroplast organelles within the plant cell.

Used to induce the development of shoot and roots along with auxin, depending on the ratio.

Plant Growth Inhibitors

Abscisic acid is a growth inhibitor that was discovered in the 1960s and initially called dormant. Later, another compound abscisin-II was discovered and are commonly called as abscisic acid. This growth inhibitor is synthesized within the stem, leaves, fruits, and seeds of the plant. Mostly, abscisic acid serves as an antagonist to Gibberellic acid. It is also known as the stress hormone as it helps by increasing the plant-tolerance to various types of stress. The function of Abscisic acid includes:

Stimulates closing of stomata in the epidermis.

Helps in the maturation and development of seeds.

Inhibits plant metabolism and seed germination.

It is involved in regulating abscission and dormancy.

It is widely used as a spraying agent on trees to regulate dropping of fruits.

Induces seed-dormancy and aids in withstanding desiccation and various undesired growth factors.

Ethylene is a simple, gaseous plant growth regulator, synthesized by most of the plant organs includes ripening fruits and ageing tissues. It is an unsaturated hydrocarbon having double covalent bonds between and adjacent to carbon atoms. Ethylene is used as both plant growth promoters and plant growth inhibitors. Ethylene is synthesized by the ripening fruits and ageing tissues. The functions of Ethylene include:

Ethylene is the most widely used plant growth regulator as it helps in regulating many physiological processes. However, it is usually the byproduct of a releasing agent such as ethephon, which when activated releases the ethylene gas.

Induce flowering in the mango tree.

Promotes sprouting of potato tubers.

Breaks the dormancy of seeds and buds.

Enhances respiration rate during ripening of fruits.

Applied to rubber trees to stimulate the flow of latex.

Facilitates senescence and abscission of both flowers and leaves.

Used to stimulate the ripening of fruits. For example, tomatoes and citrus fruits.

Affects horizontal growth of seedlings and swelling of the axis in dicot seedlings.

Increases root hair formation and growth, thus aids plant to expand their surface area for absorption.

From the foregoing, it is clear that plant growth regulators are very important in the growth and development of plants

Certain plant growth regulators (“PGRs”) such as gibberellic acid GA3, 2,4-D, GA4,7, 6BA and CPPU are used in aqueous or in granular form applied to the soil for application on crops to stimulate growth, germination, cell division, elongations, increase fruit set, branching, fruit decay and other benefits. PGRs are applied to the plants in a liquid form in high water volumes where the PGR concentration is very low, necessitating that they are applied evenly to the entire plant or tree. Unfortunately, the application and benefits are typically for a short term during certain phases of the growth cycle and typically require multiple reapplications. The short term nature of these products is due to the fact that application in a liquid form or water soluble granular, but this methodology is inefficient. Absorption, uptake and utilization by the plant is limited when applied in a foliar spray or spread in a granular form. There is little residency because the material dissipates/degrades quickly. Moreover, there are limits to the level of concentration of the PGR to water that may be offered because too much PGR in a liquid form can be detrimental to the plant or tree because it does not allow for slow release over time.

What is needed in the industry is a plant growth regulator application that improves residency time and reduces the number of applications of the PGR to the plants, while effectively utilizing the PGR at the areas where it is most needed.

### SUMMARY OF THE INVENTION

The present invention is a highly concentrated plant growth regulator, preferably in a particulate phase, suspended in a solid, semisolid, or highly viscous fluid that can be specifically targeted to areas of the plant and results in an extended, continuous release of the plant growth regulator in the targeted growth-related areas of the plant/tree. This results in not only a highly effective way to achieve growth, but also allows for a very unique application and benefit on grafted trees by sealing the graft wound and accelerating the regrowth either alone or in combination with traditional treatments. Because of the very localized and concentrated nature of the application, there is no residual contamination of soil or atmosphere that is seen with spray applications Additionally, the present invention can be used to seal pruning wounds that farmers heretofore have used Latex type products.

The present invention can be used for directly targeted application for growth both vertically (height) and laterally (feathering), root applications, and other specific uses of the PGR previously used in diluted aqueous compositions. The present invention further helps to establish grafting for growth in addition to sealing grafting wounds, and protects pruning wounds while delivering the plant growth regulator to the site to assist in branching and new growth. The used of the present invention can save a tremendous quantity of water per acre when used in groves or orchards at a huge cost savings.

These and other features of the invention will best be understood with reference to the detailed description of the preferred embodiments below.

### DETAILED DESCRIPTION OF THE PREFERRED EMBODIMENTS

As previously indicated, the application of plant growth regulators to crops and plants has historically been in the form of an aqueous spray or as a granular additive to soil supplements. These processes are very transient and their effect takes place over hours after application. The present composition and method involve finely powdered plant growth regulators that have preferably been grinded to a mean particle diameter of less than 100 μm, and more preferably to a particle size of less than 10 μm, suspended in a paste, gel, petroleum jelly, wax, viscous or highly viscous material that may applied directly to the plant and remain in contact with the plant for extended periods of time.

The formulations may be applied to specific areas of the plant for precise effects, and the composition is preferably water resistant and water insoluble, so that it will not be washed off through irrigation like so many other preparations. The present invention also results in a time release effect due to the persistent, lengthy contact of the plant growth regulator with the plant. In some examples under some conditions, the formulations will last up to four weeks before another application is needed, far exceeding any aqueous spray application. The present invention can incorporate either a single PGR or a combinations of PGRs at appropriate concentrations such that combined PGRs may act with synergy to produce the maximum desired effect.

One material that may be used as the medium for suspending the PGR is lanolin, a purified form of wool grease or wool wax, used either alone or with soft paraffin or lard or other fat as a base for ointments, emollients, skin foods, salves, superfatted soaps, and fur dressing. Lanolin, a translucent, yellowish-white, soft, unctuous, tenacious substance, is readily absorbed by the cellular membranes and thus makes an ideal base for plant products intended to be absorbed. Chemically, lanolin consists of a mixture of several sterols, fatty acids, and their esters. Additives, such as mineral oil, can be mixed with the lanolin to soften the material and make it easier to apply, such as by a tube. For example, a 90/10 composition of lanolin and mineral oil results in a much softer paste-like consistency that enabled the material to be applied directly to the plant from a squeeze tube. Other inert materials can be used to suspend the plant growth regulator, such petroleum jelly and bees wax blended with oil, semisolids, and viscous or highly viscous fluids. Here, semisolid refers to a material that can hold its shape at room temperature, but can flow or conform to a shape of a container when placed under sufficient pressure (e.g., waxes and pastes). Viscous fluids means a fluid having a viscosity of greater than 10,000 centipoise at room temperature, and highly viscous fluids have a viscosity of greater than 100,000 centipoise at room temperature. Each of these materials have specific uses in conjunction with the present invention.

The following represent three examples of products incorporating the present invention.

### Example #1

A plant treatment formulation comprised of suspending one percent by weight of Gibberellic acid (GA3) in a lanolin-based paste, and applying the composition directly to roots, trunk, or branches to enhance the linear growth of trees bushes and shrubs.

### Example #2

A plant treatment formulation is comprised of suspending one percent by weight of Gibberellic acid (GA3) and 1% of 6 Benzyladenine in a lanolin-based paste, and applying the composition directly to roots, trunk, or branches to enhance the “feathering” and branching in fruit trees and other shrubs trees and bushes where these effects are desirable.

### Example #3

A plant treatment formulation is comprised of suspending one percent by weight of Gibberellic acid (GA3) and 1% Indole acetic acid (or Indole butyric acid) in a lanolin-based paste for aiding the process of grafting onto tree stock.

These are only a few examples of the present invention, which can be extended to any PGR in combination with any other PGR to form the basis of an improved method for applying PGR where duration and site specificity are desirable. In order to have maximum benefit, in a preferred embodiment the PGRs must be ground to a very fine powder in a process akin to making colloid powders (using a colloid mill or similar). The size of the particle is preferably less than 100 μm, and more preferably less than 10 μm. In this way the solid PGR suspended in the solid, semisolid, highly viscous fluid, or viscous fluid is able to transfer to the site of application over a period of time and have maximum effect.

Certain fungicides and insecticides such as cooper and sulfur powder can also be added to the basic PGR paste formulation for added functionality. For example, pruning is quite often performed due to damage from blight, mildew or other pests. Pruning itself exposes the tree to these elements, so adding a fungicide can not only prevent further damage but resist pernicious existing conditions. Alternatively, or in addition, the medium can include or comprise a fertilizer.

We claim:

1. A plant treatment composition, comprising:
a granular plant growth regulator suspended in a medium, wherein the medium is selected from a group comprising a paste, a gel, a wax, a viscous fluid.

2. The plant treatment composition of claim 1, wherein the viscous fluid is highly viscous.

3. The plant treatment composition of claim 1, wherein the plant growth regulator has a mean particle size of less than one hundred micrometers.

4. The plant treatment composition of claim 3, wherein the plant growth regulator has a mean particle size of less than ten micrometers.

5. The plant treatment composition of claim 1, wherein the medium is a paste.

6. The plant treatment composition of claim 5, wherein the paste is a Lanolin-based paste.

7. The plant treatment composition of claim 1, wherein the medium is a wax.

8. The plant treatment composition of claim 7, wherein the wax is a bees wax.

9. The plant treatment composition of claim 8, wherein the bees wax is blended with an oil.

10. The plant treatment composition of claim 1, wherein the medium is a gel.

11. The plant treatment composition of claim 10, wherein the gel is a petroleum jelly.

12. The plant treatment composition of claim 1, wherein a concentration of plant growth regulator to medium is between 0.1% and 10.0% by weight.

13. The plant treatment composition of claim 12, wherein the concentration of plant growth regulator to medium is between 0.5% and 5% by weight.

14. The plant treatment composition of claim 13, wherein the concentration of plant growth regulator to medium is between 1% and 3% by weight.

15. The plant treatment composition of claim 1, wherein the plant growth regulator is a gibberellin.

16. The plant treatment composition of claim 15, wherein the gibberellin is gibberellic acid (GA3).

17. The plant treatment composition of claim 1, wherein the plant growth regulator is 6 Benzyladenine.

18. The plant treatment composition of claim 1, wherein the plant growth regulator is Indole butyric acid.

19. The plant treatment composition of claim 1, wherein the composition further comprises a second plant growth regulator.

20. The plant treatment composition of claim 1, wherein the composition further comprises a fungicide.

21. The plant treatment composition of claim 1, wherein the composition further comprises an insecticide.

22. The plant treatment composition of claim 21, wherein the composition further comprises a fungicide.

23. The plant treatment composition of claim 19, wherein the composition further comprises an insecticide.

24. The plant treatment composition of claim 19, wherein the composition further comprises a fungicide.

25. The plant treatment composition of claim 23, wherein the composition further comprises a fungicide.

26. The plant treatment composition of claim 1, wherein the plant growth regulator is an auxin.

27. The plant treatment composition of claim 1, wherein the plant growth regulator is a cytokinin.

28. The plant treatment composition of claim 1, wherein the plant growth regulator is an ethylene releasing agent.

29. The plant treatment composition of claim 1, further comprising copper.

30. The plant treatment composition of claim 1, further comprising a fertilizer.

31. A method for treatment of a plant, comprising:
pruning a branch to separate the branch from the plant to produce a wound; and
applying a plant growth regulator suspended in a medium selected from a group comprising a paste and a gel, at the wound for a duration of at least one week.

32. The method for treatment of a plant of claim 31, wherein the plant growth regulator is a gibberellin.

33. The method for treatment of a plant of claim 32, wherein the gibberellin is gibberellic acid (GA3).

34. The method for treatment of a plant of claim 33, wherein the medium further comprises a second plant growth regulator.

35. The method for treatment of a plant of claim 34, wherein the second plant growth regulator is 6 Benzyladenine.

36. The method for treatment of a plant of claim 34, wherein the second plant growth regulator is Indole butyric acid.

37. The method for treatment of a plant of claim 31, wherein the composition further comprises a fungicide.

38. The method for treatment of a plant of claim 31, wherein the composition further comprises an insecticide.

39. The method for treatment of a plant of claim 31, wherein the composition further comprises a fertilizer.

40. The method for treatment of a plant of claim 38, wherein the composition further comprises a fungicide.

41. The method for treatment of a plant of claim 39, wherein the composition further comprises a fungicide.

42. The method for treatment of a plant of claim 31, wherein the plant growth regulator is a cytokinin.

43. The method for treatment of a plant of claim 31, wherein the plant growth regulator is an ethylene releasing agent.

44. The method for treatment of a plant of claim 31, wherein the plant growth regulator is abscisic acid.
